(19) United States
(12) Patent Application Publication
(10) Pub. No.: US 2010/0179799 A1
(43) Pub. Date: Jul. 15, 2010

(54) Simulation Device, Simulation Program, and Recording Medium Storing Simulation Program

(75) Inventors: Toshihide SHINOHARA, Chino-shi (JP); Tadashi KAGA, Nagano-ken (JP)

Correspondence Address: Hogan Lovells US LLP, 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/638,758

(22) Filed: Dec. 15, 2009

(30) Foreign Application Priority Data
Jan. 13, 2009 (JP) 2009-004962

(51) Int. Cl. G06G 7/60; G06K 9/00

(52) U.S. Cl. 703/11; 382/107

(57) ABSTRACT

A simulation device includes: a design data acquisition section adapted to acquire lens design data; a lens designing section adapted to design a lens based on the lens design data; an original image data acquisition section adapted to acquire original image data constituting an observation virtual space to be an object of observation by a lens user; a visual motion characteristic data acquisition section adapted to acquire visual motion characteristic data related to motions of a head and eyeballs when the lens user transfers an visual axis to various observation targets; an image processing section adapted to generate processed image data as the original image data viewed through a designed lens designed by the lens designing section; an image moving section adapted to move the processed image data; an image data control section adapted to control a moving distance of the processed image data moved by the image moving section based on the visual motion characteristic data; and a display section adapted to display the processed image data.

### BACKGROUND

1. Technical Field

The present invention relates to a simulation device and a simulation program for simulating a vision provided by a lens, and a recording medium storing the simulation program.

2. Related Art

In the past, there has been known a simulation device for simulating a vision provided by a lens such as a spectacle lens on a display area of a display device (JP-A-2000-107129 (Document 1), JP-A-2002-45336 (Document 2)). These documents, namely the Documents 1 and 2, relate to a simulation of a vision accompanied by sway, distortion, blur, and so on in the case of mounting a lens such as a progressive power lens. In the related art examples shown in the Documents 1 and 2, a visual motion characteristic, namely the fact that some people (hereinafter referred to as head movers) move mainly the heads when turning the gaze on the object, and other people (hereinafter referred to as eye movers) move mainly the eyes is not considered.

Here, the visual motion characteristic of the lens user will be explained based on FIGS. 8A, 8B, 9A, and 9B.

FIGS. 8A and 8B are schematic diagrams showing the motions of the head and the eyes of the lens user in a vertical direction (an up-and-down direction). FIG. 8A shows the state in which the lens user has a natural horizontal view, and FIG. 8B shows the state in which the lens user views an object O located on the lower side. Compared to the state shown in FIG. 8A, the forward tilt angle θ of the head H of the lens user and the turning angle α of the eyeball I exist in the state shown in FIG. 8B.

FIGS. 9A and 9B show the motions of the head and the eyes in a horizontal direction (the lateral direction), wherein FIG. 9A shows the state in which the lens user looks front in a horizontal plane, and FIG. 9B shows the state in which the lens user looks at the object O located on the right side in the horizontal plane. Compared to the state shown in FIG. 9A, the rotating angle θ of the lateral rotation of the head H of the lens user and the turning angle α of the eyeball I exist in the state shown in FIG. 9B.

The lens user having the ratio between the head motion θ and the eye motion α satisfying θ>>α is the head mover, and the lens user with the ratio satisfying θ<<α is the eye mover. People are not clearly divided into the two groups, namely the head mover group and the eye mover group, but intermediate head movers and intermediate eye movers also exist. The visual motion characteristic of the lens user, such as the head mover or the eye mover, should be considered in the design of the progressive power lens.

The visual motion characteristics of the head mover and the eye mover are habits along which humans do things unconsciously. In contrast, when looking carefully at an observation object, a human generally heads straight toward the observation object. In this case, it takes an action of a perfect head mover.

In general, the progressive power lens has a distance portion, which is an area located in the upper half of the lens and is used for viewing the distance, a near portion, which is located in the lower side apart from the distance area and is used for viewing the adjacent area, and a progressive portion in which the refractive power varies progressively between the distance portion and the near portion. The progressive power lens has optical distortion (e.g., astigmatism and distortion) on the lateral sides of the lens, mainly on the lateral sides of the progressive portion and the near portion, where an image with blur or distortion is observed. The astigmatism causes the image to blur, and if the astigmatism in a portion becomes large, it becomes impossible to view the object clearly through the portion. In general, it is regarded that the portion with the level of the astigmatism is equal to or lower than 0.5 dioptre can be used without causing the observer to feel substantial blur, and such a portion is called a “clear vision area.” There are two types in the progressive power lens design, one with large clear vision areas of the distance portion and the near portion is called a hard design, while the other thereof with narrow clear vision areas of the distance portion and the near portion is called a soft design, in contrast thereto.

The hard design has an advantage that the lens becomes eye-friendly because of the large clear vision areas of the distance portion and the near portion, but has a disadvantage that significant astigmatism is caused in the lateral sides of the progressive portion to narrow the clear vision area of the progressive portion, and thus big and uncomfortable sway is caused when moving the head, on the negative side.

The soft design has a disadvantage that the clear vision areas of the distance portion and the near portion are narrow, but has an advantage that the astigmatism and the distortion in the progressive portion are little, and thus the clear vision area in the progressive portion becomes large to cause only small sway.

The progressive power lens with the soft design is better suited for the lens user as the head mover, while the progressive power lens with the hard design is better suited for the lens user as the eye mover.

There exists related art considering the visual motion characteristics of the head mover and the eye mover. The related art example relates to a method of performing classification from the viewpoint of the motion of the head and the eyes, and then recommending the design of the spectacle lens, in particular of the progressive power lens based on the classification (JP-T-2003-523244 (Document 3), the term “JP-T” as used herein means a published Japanese translation of a PCT patent application).

However, in the related art example described in the Document 3, although it is possible to recommend the spectacle lens for the eye movers or the head movers, measures for confirming whether or not the design is suited to the lens user him- or herself are not yet disclosed.

As the method of confirming whether or not the lens is suited to the lens user, there can be considered a method of preparing typical lenses, called trial lenses or wearable test lenses, corresponding respectively to the design types, and inserting them in an overlapping manner in a frame for optometry to which an optometric lens for correcting ametropia of the lens user is set, thereby providing an experience of wearing the lenses.

However, in this method, although the simulated experience with the trial lenses designed for the typical head mover and the typical eye mover is possible, it is virtually difficult to cope with all cases with various degrees of the head mover or the eye mover.

### SUMMARY

Some aspects of the invention have an advantage of providing a simulation device and a simulation program capable of simulating the vision with the lens in consideration of the visual motion characteristic with respect to the motions of the head and the eyes of the lens user viewing an object, and a recording medium storing the simulation program.

A simulation device according to an aspect of the invention includes a design data acquisition section adapted to acquire lens design data, a lens designing section adapted to design a lens based on the lens design data, an original image data acquisition section adapted to acquire original image data constituting an observation virtual space to be an object of observation by a lens user, a visual motion characteristic data acquisition section adapted to acquire visual motion characteristic data related to motions of a head and eyeballs when the lens user transfers a visual axis to various observation targets, an image processing section adapted to generate processed image data as the original image data viewed through a designed lens designed by the lens designing section, an image moving section adapted to move the processed image data, an image data control section adapted to control a moving distance of the processed image data moved by the image moving section based on the visual motion characteristic data, and a display section adapted to display the processed image data.

According to this aspect of the invention, the lens designing section of the simulation device designs the lens based on the lens design data acquired by the design data acquisition section. In this case, the shape of the edge of the lens to be designed can be a shape (generally a circular shape) to be edged or an edged shape. The original image data acquisition section acquires the original image data for constituting the observation virtual space to be the object of the observation by the lens user. The visual motion characteristic data acquisition section acquires the visual motion characteristic data related to the motions of the head and the eyeballs when the lens user transfers the visual axis to various observation targets. In other words, the visual motion characteristic data acquisition section acquires the visual motion characteristic data related to the motions of the head and the eyeballs when the lens user views a plurality of observation targets existing at different positions one after another, or when the lens user views a moving observation object continuously. Here, the visual motion characteristic data can be digitalized by, for example, attaching the device for detecting the position and the posture of the head of the lens user to the head, then making the lens user repeatedly look at the objects located on the left, right, upper, and lower sides, and then detecting the motions of the head and the eyeballs.

Further, the image processing section generates the processed image data as the original image data viewed through the designed lens designed by the lens designing section. Specifically, the image processing section processes the original image described above to form the processed image data. Further, when the image data control section receives the visual motion characteristic data acquired by the visual motion characteristic data acquisition section, the image data control section sends a signal to the image moving section, and then the image moving section moves the processed image data a predetermined moving distance. Then, the processed image data thus moved is displayed on the display section. In the display section, both of the processed image data before the movement by the image moving section and the processed image data after the movement by the image moving section are displayed.

In other words, according to this aspect of the invention, since the processed image data is moved in accordance with the visual motion characteristic data (the visual motion characteristic) related to the motions of the head and the eyeballs of the lens user, the vision by the lens corresponding to the visual motion characteristic of the individual lens user can effectively be simulated.

In the simulation device according to the aspect of the invention described above, it is preferable that the visual motion characteristic data acquired by the visual motion characteristic data acquisition section is the ratio between the turning amount of the head of the lens user and the turning amount of the eyeballs thereof.

According to this aspect of the invention, since the visual motion characteristic of the lens user should be determined mainly in accordance with the ratio between the turning amount of the head and the turning amount of the eyeballs, the vision by the lens can be simulated based on the visual motion characteristic corresponding to the individual lens user.

In the simulation device according to the aspects of the invention described above, it is preferable that the image data control section has a normal mode for moving the processed image data in accordance with the turning amount of the eyeballs acquired by the visual motion characteristic data acquisition section.

According to this aspect of the invention, the vision by the lens can easily and simply be simulated in accordance with the visual motion characteristic of the individual lens user. In particular, in the case in which the viewing field can be limited to a narrow range, since it is possible to move the processed image data in accordance with only the turning amount of the eyeballs without considering the motion of the head assuming that the lens user is substantially the complete eye mover, an amount of calculation can be reduced, and therefore the simulation can quickly be performed.

In the simulation device according to the aspects of the invention described above, it is preferable that the image data control section has a gaze mode for moving the processed image data in accordance with a total value of the turning amount of the head and the turning amount of the eyeballs acquired by the visual motion characteristic data acquisition section.

According to this aspect of the invention, since the vision by the lens is simulated with respect to various types of people from the eye mover to the head mover, the determination on whether or not the designed lens is suited to the user can more precisely be made.

In the simulation device according to the aspects of the invention described above, it is preferable that the lens is the progressive power lens provided with the distance portion for viewing the distance, the near portion for viewing the neighboring area, and the progressive portion having the refractive power varying progressively between the distance portion and the near portion.

According to the simulation device of this aspect of the invention, the vision by the progressive power lens can be determined in accordance with the visual motion characteristic of the individual lens user.

Further, in the aspects of the invention described above, it is preferable that the lens designing section designs two types of lenses, one with the large distance portion, the large near portion, or the large distance and near portions, the other with the narrow distance portion, the narrow near portion, or the narrow distance and near portions.

According to this aspect of the invention with the configuration described above, the lens user can determine which one of the progressive power lens with the hard design having a feature of the large clear view area in the distance portion and the near portion and the progressive power lens with the soft design having a feature of the narrow clear view area in the distance portion and the near portion is better suited via the simulation device.

A simulation program according to another aspect of the invention allows a computing device to function as the simulation device described above.

According to this aspect of the invention, the computing device can be made to function as the simulation device described above by the simulation program. Thus, the lens user can easily compare the visions by the lenses corresponding respectively to the visual motion characteristics.

A recording medium storing an simulation program according to still another aspect of the invention stores the simulation program described above in such a manner that the computing device can retrieve the simulation program.

According to this aspect of the invention, the recording medium stores the simulation program described above in such a manner that the computing device can read the simulation program. Thus, it becomes possible to make the computing device perform a read operation on the recording medium, thereby enabling the computing device to execute the simulation program described above.

### BRIEF DESCRIPTION OF THE DRAWINGS

The invention will be described with reference to the accompanying drawings, wherein like numbers reference like elements.

FIG. 1 is a schematic diagram showing a configuration of a simulation device according to an embodiment of the invention.

FIG. 2 is a flowchart showing an operation of the simulation device according to the present embodiment.

FIG. 3 is a flowchart showing a procedure of an image moving process.

FIG. 4 is a diagram showing an original image in the simulation.

FIGS. 5A through 5C are diagrams for explaining processed image data obtained by processing the image data of the original image.

FIGS. 6A through 6C are diagrams for explaining the case of displaying the view with the progressive power lens by the soft design.

FIGS. 7A through 7C are diagrams for explaining the case of displaying the view with the progressive power lens by the hard design.

FIGS. 8A and 8B are schematic diagrams showing the motions of the head and the eyes of the lens user in a vertical direction (an up-and-down direction).

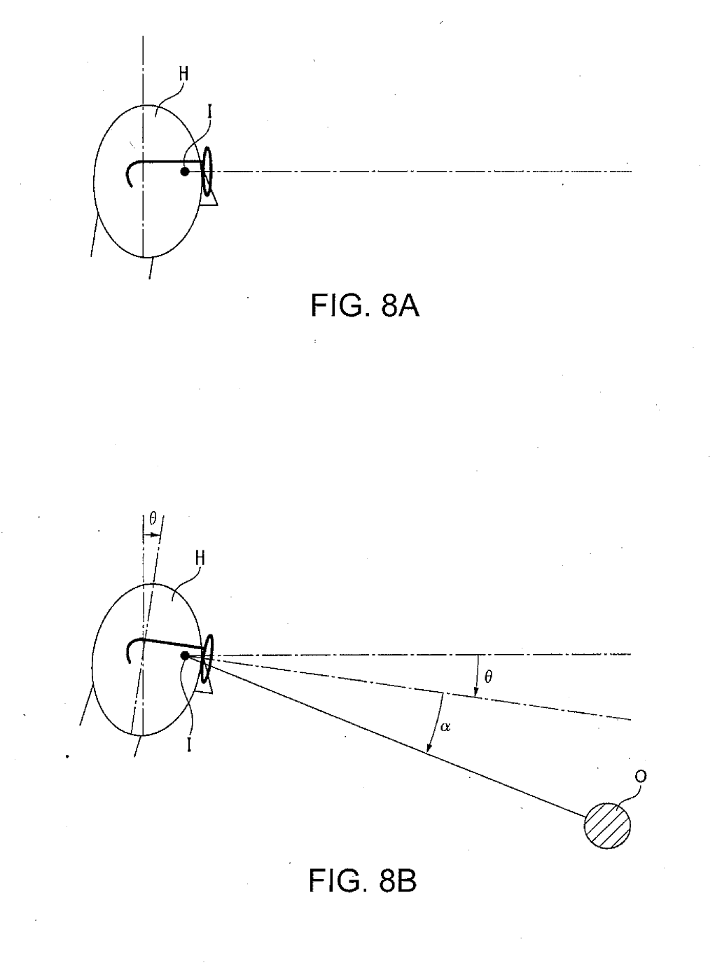

FIGS. 9A and 9B are schematic diagrams showing the motions of the head and the eyes of the lens user in a horizontal direction (a lateral direction).

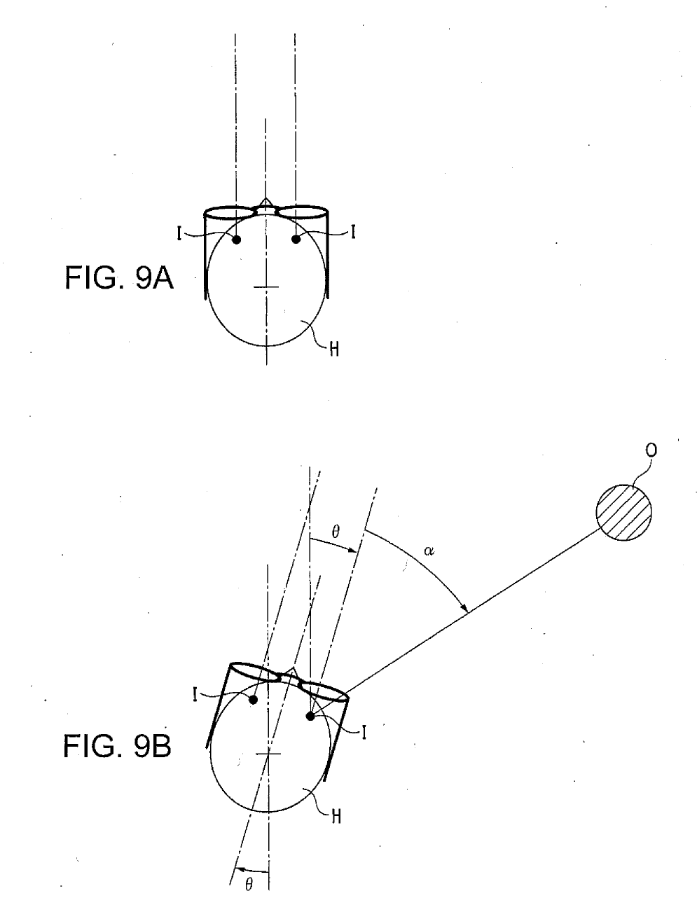

### DESCRIPTION OF AN EXEMPLARY EMBODIMENT

A simulation device according to an embodiment of the invention will hereinafter be explained with reference to the accompanying drawings.

### Configuration of Simulation Device

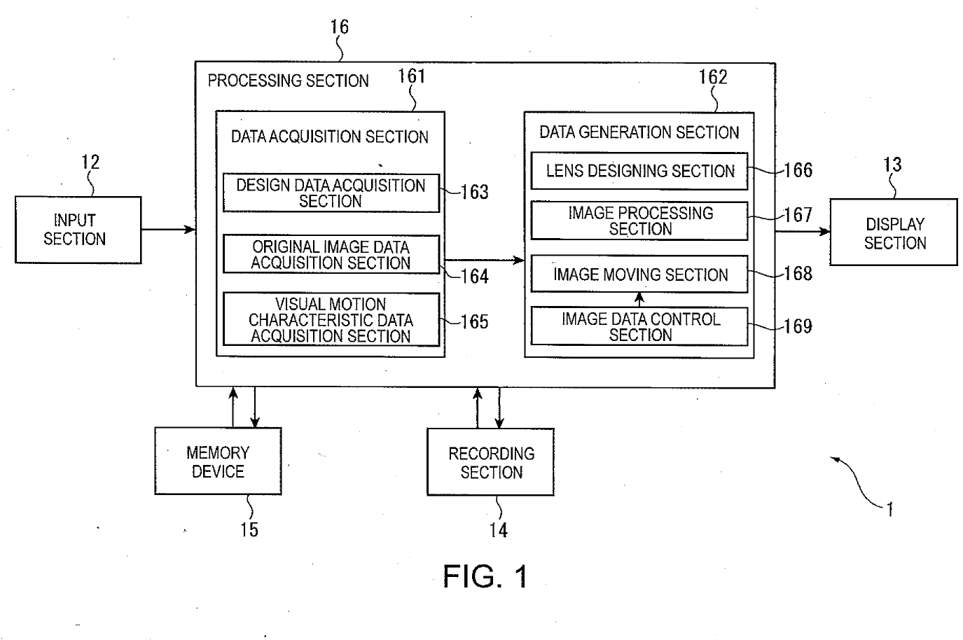

FIG. 1 shows a schematic configuration of the simulation device 1 according to the present embodiment.

The simulation device 1 is installed in, for example, a store for spectacle lenses.

It should be noted that although a personal computer is exemplified in the present embodiment as the simulation device 1, the simulation device 1 is not limited thereto, but other computing devices such as a portable phone can also be used as the simulation device 1.

As shown in FIG. 1, the simulation device 1 is provided with an input section 12, a display section 13 as a display device, a recording section 14 as an image recording device, a memory device 15, a processing section 16, and so on.

The input section 12 is constituted with, for example, a keyboard and a mouse, and has various operation buttons and operation knobs, not shown, on which an input operation is executed.

The input operation on these operation buttons and operation knobs corresponds to a setting input of a setting item such as setting of an operation content of the simulation device 1 or setting of information to be stored in the simulation device 1.

Further, in response to the input operation for the setting item, the input section 12 outputs a signal corresponding to the setting item to the processing section 16 according to needs, thereby performing the setting input.

It should be noted that the input operation is not limited to the operation of the operation buttons or the operation knobs, but a configuration of performing the setting input of the various setting items by, for example, an input operation with a touch panel provided to the display section 13 or an input operation with a voice can also be adopted.

The display section 13 is controlled by the processing section 16, and performs screen display in a display area not shown in accordance with the signal of the image information input from the processing section 16.

As the display section 13, a liquid crystal panel, an organic electroluminescence (EL) panel, a plasma display panel (PDP), a cathode-ray tube (CRT), a field emission display (FED), an electrophoretic display panel, for example, can be cited.

The recording section 14 stores, namely memorizes in a retrievable manner, various data such as customer data, the original image subject to the simulation, image data obtained by the simulation, or visual motion characteristic data.

As the recording section 14, a configuration provided with a drive and a driver for storing the data in a retrievable manner into a recording medium such as a hard disk, a digital versatile disc (DVD), an optical disk, or a memory card can also be adopted.

Here, the customer data is the data related to the prescription of the lens ordered by the customer as the lens user. The customer data is configured as unified data including customer ID data, prescription data, lens shape design data, and so on correlated with each other.

It should be noted that the lens design data of the embodiment of the invention is constituted with the prescription data and the lens shape design data.

The customer ID data is unique information for identifying the customer data, and is set for each customer data. As the customer data, for example, a customer number set for each customer, and customer individual information related to the name and so on of the customer can be cited.

The prescription data is the data related to the eye of the customer and the prescription of the lens corresponding to the customer data identified by the customer ID data. As the prescription data, eye data related to the eye of the customer, lens prescription data related to the prescription of the lens to be designed, and so on are recorded.

As the eye data, information related to the naked eye of the customer, such as the visual acuity or presence or absence of astigmatism of the customer, is recorded. Further, as the lens prescription data, the data related to the power, additional power, spherical power, cylindrical power, a cylinder axis, prismatic power, near inset, and so on of the lens is recorded.

The lens shape design data is the data related to the shape of the lens. For example, the refractive index and the Abbe number of the lens material, coordinate value data of the refracting surfaces (the front surface and the rear surface) of the lens, thickness data such as a thickness of the center of the lens, data related to a design parameter such as a progressive corridor length, and so on are recorded. Further, the data of the refractive function (e.g., the refractive power and the prism function) at respective points on the lens can be included.

The memory device 15 stores setting items on which the input operation is executed in the input section 12, sound information, image information, and so on in a retrievable manner according to needs. Further, the memory device 15 stores various programs developed on an operating system (OS) for controlling driving of the entire simulation device 1. It should be noted that as the memory device 15, the configuration provided with a drive for storing data in a retrievable manner into a recording medium such as an HD, a DVD, or an optical disk, and a driver therefor can also be adopted.

The processing section 16 has various types of input/output ports not shown, such as a key input port to which the input section 12 is connected, a display port to which the display section 13 is connected, a storage port to which the recording section 14 is connected, and a memory port to which the memory device 15 is connected.

Further, the processing section 16 is provided with a data acquisition section 161, a data generation section 162, and so on as the various programs as shown in FIG. 1.

The data acquisition section 161 recognizes the input signal caused by the input operation executed on the input section 12 by the user, and acquires various data based on the input signal. Further, the data acquisition section 161 acquires various data from the recording section 14.

The data acquisition section 161 has a design data acquisition section 163 for acquiring the lens design data, an original image data acquisition section 164 for acquiring the original data for forming the observation virtual space to be an object of the observation by the customer (the lens user), and a visual motion characteristic data acquisition section 165 for acquiring the visual motion characteristic data related to the motions of the head and the eyeballs when the lens user transfers the visual axis to various observation targets.

The data generation section 162 generates new data from the various data acquired in the data acquisition section 161.

Specifically, the data generation section 162 has a lens designing section 166 for designing the lens (the designed lens) to be edged based on the lens design data, an image processing section 167 for generating processed image data, which is the data of the original image viewed by the lens user through the designed lens, an image moving section 168 for moving the processed image data generated in the image processing section 167, and an image data control section 169 for controlling the moving distance of the processed image data moved by the image moving section 168 based on the visual motion characteristic data acquired by the visual motion characteristic data acquisition section 165. It should be noted that the image processing section 167 specifically processes the original image data acquired by the original image data acquisition section 164 described above to generate the processed image data.

Further, the image data control section 169 has the visual axis transfer position designation mode for designating the visual axis transfer position of the visual motion characteristic data acquired by the visual motion characteristic data acquisition section 165, a normal mode for moving the processed image data in accordance with the turning amount of the eyeballs acquired by the visual motion characteristic data acquisition section 165, and a gaze mode for moving the processed image data in accordance with the total value of the turning amount of the head and turning amount of the eyeballs acquired by the visual motion characteristic data acquisition section 165, and these modes are switched in accordance with a signal from the input section 12.

### Operation of Simulation Device

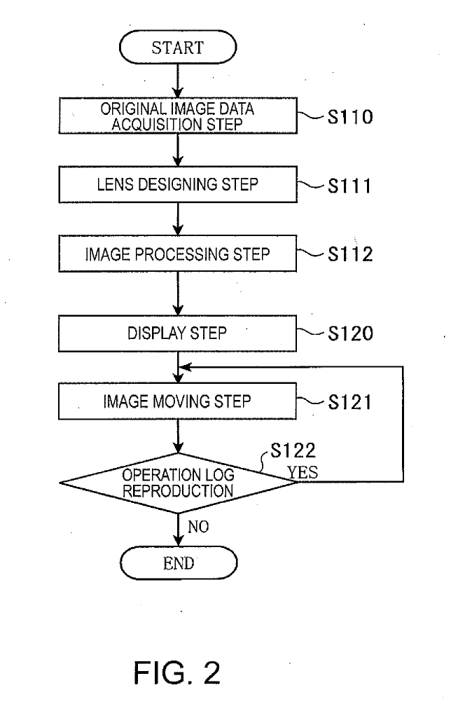

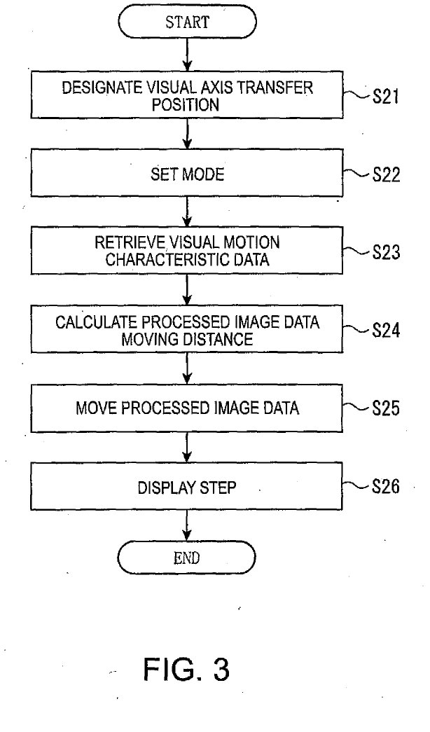

Hereinafter, the operation of the simulation device 1 will be explained with reference to FIGS. 2 and 3.

It should be noted that in the present embodiment, the lens is the progressive power lens provided with the distance portion for viewing the distance, the near portion for viewing the neighboring area, and the progressive portion having the refractive power varying progressively between the distance portion and the near portion.

Firstly, the visual motion characteristic data related to the motions of the head and the eyeballs when the lens user views the moving observation target is obtained using a separate device. As such a device, the “Varilux® Vision Print System™” produced by Nikon-Essilor Co., Ltd., for example, can be used.

The visual motion characteristic data can be digitalized by attaching the device for detecting the position and the posture of the head of the lens user to the head, then making the lens user repeatedly look at the objects located on the left, right, upper, and lower sides, and then detecting the motions of the head and the eyeballs.

For example, the ratio between the turning angle θ of the head and the turning angle α of the eyes is quantified as θ:α=4:6. The visual motion characteristic data is stored into the recording section 14 in accordance with the operation of the input section 12. It should be noted that since θ:α=1.0:0 is satisfied in the case of the extreme head mover, and θ:α=0:10 is satisfied in the case of the extreme eye mover, the visual motion characteristic data is input accordingly.

FIG. 2 is a flowchart showing an operation of the simulation device according to the present embodiment of the invention.

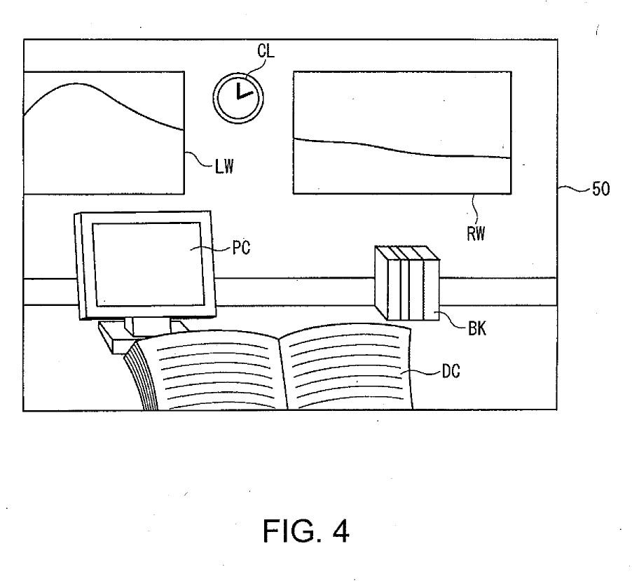

Firstly, in an original image data acquisition step S110, the original image data acquisition section 164 reads the original image 50 of the simulation (see FIG. 4) and the vision data of the customer from the recording section 14. The original image 50 is an example of the observation virtual space, composed of various original data, while imaging an office. Although landscapes through left and right windows LW, RW, a clock CL on the wall, a personal computer PC on a desk, a document DC at hand, and books BK standing on the desk are expressed two-dimensionally, such objects are disposed actually in the three-dimensional space as three-dimensional data. It should be noted that the original image 50 described above is an example, but not a limitation, and other images such as sceneries, figures, or objects can also be used as the original image 50.

Subsequently, in a lens designing step S111, the design data acquisition section 163 reads the lens design data from the recording section 14, and then the lens designing section 166 designs the lens (the designed lens) to be edged, based on the lens design data thus read. It should be noted that it is also possible to design an edge shape on a lens obtained by cutting the designed lens so as to have an edged shape.

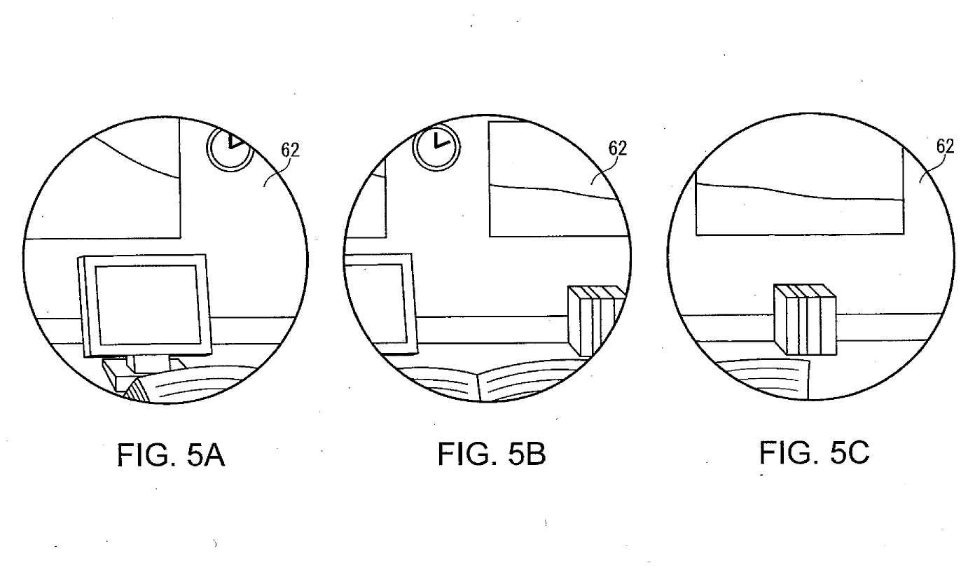

In an image processing step S112, the image processing section 167 performs image processing so that the image becomes in the state obtained by the lens user viewing the original image 50 through the designed lens, thereby obtaining the processed image data 62 (see FIGS. 5A through 5C). The processed image data 62 thus obtained is recorded on the recording section 14. It should be noted that in FIGS. 5A through 5C, the blur caused by the astigmatism, the enlargement of the image caused in the near portion, and the distortion of the image caused in the progressive portion, which are features in the vision obtained by the progressive power lens, are omitted from the description.

In a display step S120, the processed image data 62 recorded on the recording section 14 is retrieved, and then displayed on the display section 13.

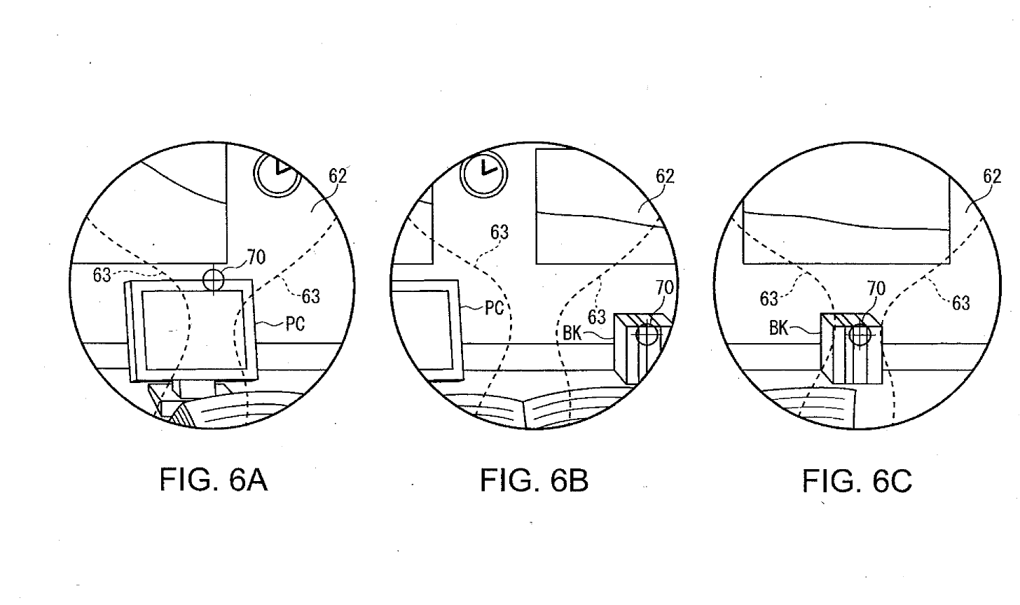

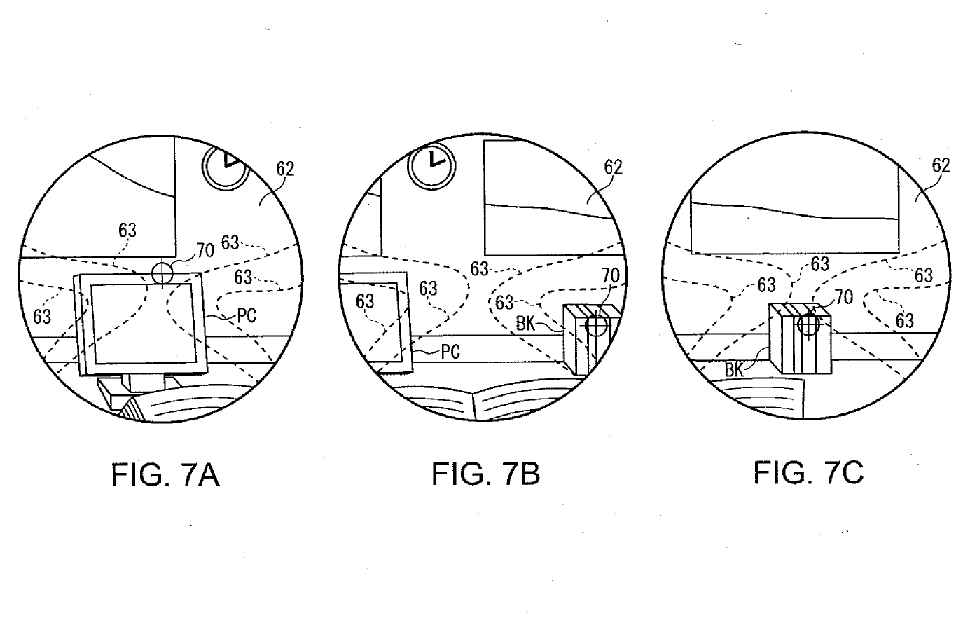

In the image displayed on the display section 13, the broken lines 63 are displayed in the lens as shown in FIGS. 6A and 7A. The broken lines 63 represent the boundaries between an area including the distance portion, the progressive portion, and the near portion of the designed lens which is a progressive power lens, and areas (the lower left and right portions of the lens) unavailable due to the optical distortion. The image processing is executed on the processed image data 62 so that the visions of the images located on both sides of the broken line 63 are different from each other. It should be noted that similarly to FIGS. 5A through 5C the blur caused by the astigmatism, the enlargement of the image caused in the near portion, and the distortion of the image caused in the progressive portion, which are features in the vision obtained by the progressive power lens, are omitted from the description in FIGS. 6A through 6C, and 7A through 7C. Further, although the broken lines 63 are not clearly recognized in the actual use of the progressive power lens, and therefore not necessarily required on the simulation, the result of the simulation can more clearly be understood by providing the broken lines 63.

After the display step S120, an image moving step S121 is executed. The procedure of the image moving step S121 is shown in FIG. 3.

In FIG. 3, firstly, designation of the visual axis transfer position is executed (S21). In the visual axis transfer position designation step, when performing the simulation after horizontally transferring the viewing field obtained through the lens from the left position to the right position in FIG. 4 as shown in FIGS. 5A through 5C, for example, the visual axis transfer position is designated. In FIG. 4, for example, the designation of the transfer position of the visual axis is preferably performed by such an easy and simple method as to point out the position of the frame of the window RW above the books BK displayed on the right side using a cursor corresponding to a mouse constituting the input section 12.

Subsequently, either one of the normal mode and the gaze mode is set with the image data control section 169 via the input section 12 (S22).

Then, a step of retrieving the visual motion characteristic data from the recording section 14 is executed (S23), and then the moving distance of the processed image data 62 is calculated (S24).

In the step S24 of calculating the moving distance of the processed image data, the moving distance of the processed image data 62 is obtained from the visual motion characteristic data retrieved from the recording section 14 and the moving distance designated in the visual axis transfer position designation step.

For example, in the case in which the ratio between the turning angle θ of the head and the turning angle α of the eyes satisfies θ:α=4:6, and the position of the screen is moved a distance corresponding to the angle of 30° as a whole, the turning angle of the head is 30°×0.4=12° in the rightward direction, and the turning angle of the eyes is 30°×0.6=18° in the rightward direction (the gaze mode). In general, if the lens user is the head mover, the turning angle of the eyes becomes smaller, and if the lens user is the eye mover, the turning angle of the eyes, becomes greater.

The processed image data 62 is moved (S25) the distance obtained by the calculation in the image data moving distance calculation step S24 described above. The processed image data 62 is continuously moved in the order of, for example, FIG. 5A, FIG. 5B, and FIG. 5C. Although the processed image data 62 is moved from FIG. 5A to FIG. 5C in the case in which the lens user is the head mover, the processed image data 62 is only moved from FIG. 5A to FIG. 5B in the case in which the lens user is the eye mover.

The processed image data 62 of each of the drawings is displayed on the display section 13 (S26).

For example, in the case of the progressive power lens with the soft design, the images are displayed in the order of FIG. 6A, FIG. 6B, and FIG. 6C. In FIGS. 6A through 6C, the progressive power lens is designed to have a relatively narrow clear vision areas of the distance portion and the near portion, and the image with suppressed astigmatism and distortion in the lateral sides is displayed. In the drawing, the reference numeral 70 indicates a position where the visual axis of the lens wearer passes through, namely the center of a gaze. In FIGS. 6B and 6C, the center 70 of the gaze indicates the books BK.

The difference in the simulation between the head mover and the eye mover will be explained using FIGS. 6A through 6C. In the case of the head mover, the visual axis is moved up to FIG. 6C where the outside of the right side window and the books BK are viewed at the front while keeping the visual axis at the front. On the other hand, in the case of the eye mover, since the turning is anchored by the turning of the eyes, the eye mover turns the head halfway up to FIG. 6B, and then tries to look using the lateral side of the lens by turning the eyes the remaining distance. Therefore, in the case of the eye mover, the books BK and a part of the area in the window frame RW are viewed through the lateral sides of the designed lens, as a result. As described above, the vision of the head mover changes from FIG. 6A to FIG. 6C, and the vision of the eye mover changes from FIG. 6A to FIG. 6B.

In the case of the progressive power lens with the hard design, the images are displayed in the order of FIG. 7A, FIG. 7B, and FIG. 7C. Since in the progressive power lens relatively significant astigmatism exists compared to the lens with the soft design in FIGS. 7A through 7C, the broken lines 63 are described double in FIGS. 7A through 7C. In the drawing, the reference numeral 70 indicates a position where the visual axis of the lens wearer passes through, namely the center of the gaze. In FIGS. 7B and 7C, the center 70 of the gaze indicates the books BK.

In FIGS. 7A through 7C, similarly to FIGS. 6A through 6C, in the case of the head mover, a part of the books BK is viewed through the central portion of the designed lens, and in the case of the eye mover, the books BK is viewed through the lateral side of the designed lens, as a result. As described above, the vision of the head mover is represented from FIG. 7A to FIG. 7C, and the vision of the eye mover is represented from FIG. 7A to FIG. 7B.

In each of the progressive power lenses described above, the processed image data 62 before and after the movement is stored in the recording section 14.

Here, with reference to FIGS. 6A through 6C and 7A through 7C, appropriateness of the lens thus designed for the head mover and the eye mover will be explained.

Since the head mover turns (moves) the head (the face) significantly with respect to the observation target, the soft design with small sway as shown in FIG. 6 is suited. On the other hand, in the hard design as shown in FIGS. 7A through 7C, due to the great movement of the head, the sway caused by the heavy distortion in the progressive portion is felt to be more terrible.

In contrast, in the case of the eye mover, since only little turn of the head is required, and the lateral side can be viewed clearly with the turn of the eyes thereafter, the hard design providing the large distance portion and the large near portion shown in FIGS. 7A through 7C is advantageous. Further, it is also effective for reducing the sensitivity to the sway due to the heavy distortion that the movement of the head can be reduced. It should be noted that the head movers and the eye movers are not clearly separated from each other, but the most lens users have the both characteristics at ratios different from each other. Further, the progressive power lenses do not necessarily belong to either those with the clear hard design or those with the clear soft design, but there exist many progressive power lenses belonging to an intermediate type having the both characteristics.

Going back to FIG. 2, whether or not an operation log is reproduced is selected (S122). In the case of reproducing the operation log, the operator runs the image data control section 169 via the input section 12. Then, the processed image data 62 before and after the movement recorded on the recording section 14, namely the images shown in FIGS. 6A through 6C or FIGS. 7A through 7C are displayed repeatedly on the display section 13. In the case of stopping the reproduction of the operation log, the operator runs the image data control section 169 via the input section 12. In the case of not reproducing the operation log, the operator performs an ending operation on the image data control section 169 via the input section 12.

### Functions and Advantages of Embodiment

According to the present embodiment described above, the following advantages can be obtained.

1. The simulation device 1 is provided with the visual motion characteristic data acquisition section 165 for acquiring the visual motion characteristic data related to the motions of the head and the eyeballs when the lens user transfers the visual axis to various observation targets, the image data control section 169 for controlling the moving distance of the processed image data 62 moved by the image moving section 168 based on the visual motion characteristic data acquired by the visual motion characteristic data acquisition section 165, and the display section 13 for displaying the processed image data 62. Therefore, since both of the processed image data 62 before the movement and the processed image data 62 after the movement are displayed on the display section 13, the vision by the lens corresponding to the visual motion characteristic of each lens user can be simulated.

2. Since the visual motion characteristic data acquired by the visual motion characteristic data acquisition section 165 is the ratio between the turning angle θ of the head of the lens user and the turning angle α of the eyes thereof, the vision by the lens corresponding to the visual motion characteristic of the individual lens user can be simulated.

3. The image data control section 169 is arranged to have the configuration having the normal mode for moving the processed image data 62 in accordance with the amount of turn of the eyeballs, and the gaze mode for moving the processed image data 62 in accordance with the total value of the turning angle θ of the head and the turning angle α of the eyes regardless of the ratio between the both parties, and selecting one of these modes. Therefore, by setting the normal mode, the vision through the designed lens can easily and simply be simulated, and in addition, by setting the gaze mode, the vision in the case in which the lens user, either the head mover or the eye mover, transfers the visual axis attempting to gaze an object can be simulated.

4. Since there is provided the data of two types of lenses, namely the lens with a large distance portion, a large near portion, or large distance and near portions and the lens with a narrow distance portion, a narrow near portion, or narrow distance and near portions, the lens user can determine through the simulation device which one of the progressive power lens with the hard design and the progressive power lens with the soft design is better suited.

5. Since the step of reproducing the operation log is executed, it is possible to repeatedly display both of the processed image data 62 before the movement and the processed image data 62 after the movement on the display section 13 using the data input once as a base.

### Modified Example of Embodiment

It should be noted that the invention is not limited to the embodiment described above, but includes the modifications described below within the range where the advantage of the invention can be obtained.

Although in the embodiment described above there are provided two modes, namely the normal mode and the gaze mode, for the mode setting, a combination of the normal mode and the gaze mode in which the mode is switched automatically from the normal mode to the gaze mode is also possible. Specifically, the observation behavior common in daily life that the lens user moves the visual axis in the normal mode to roughly recognize the object, and then sets the face straight toward the object for clearer vision can be simulated with the mode. In the explanation of the display images in that case using FIGS. 6A through 6C, the image changes from FIG. 6A up to FIG. 6B, and after a little pause, further changes to FIG. 6C.

Although in the embodiment described above the explanations are presented assuming the case in which the spectacle lens is formed of the progressive power lens, the invention can be applied to the case with a single focus lens. In this case, it is not required to display the broken lines 63 in addition to the processed image data 62. Even in the case with the progressive power lens, it is not necessarily required to indicate the boundaries between the area constituted with the distance portion, the progressive portion, and the near portion, and the portion unavailable due to the optical distortion using the broken lines 63. The customer can recognize the difference in vision due to the variation of the sizes of the respective areas without the broken lines 63.

Further, although in the embodiment described above it is assumed that the processed image data 62 is moved in the lateral direction (horizontally), those moving the image vertically or obliquely can also be adopted in the invention.

Further, the invention can also be configured as a simulation program for making a computing device such as a computer function as the simulation device 1, or a recording medium such as a CD-ROM or a memory card having the simulation program recorded in such a manner that the computing device can retrieve the simulation program, besides the simulation device 1 described in the embodiment.

The entire disclosure of Japanese Patent Application No: 2009-004962, filed Jan. 13, 2009 is expressly incorporated by reference herein.

What is claimed is:

1. A simulation device comprising:
a design data acquisition section adapted to acquire lens design data;
a lens designing section adapted to design a lens based on the lens design data;
an original image data acquisition section adapted to acquire original image data constituting an observation virtual space to be an object of observation by a lens user;
a visual motion characteristic data acquisition section adapted to acquire visual motion characteristic data related to motions of a head and eyeballs when the lens user transfers an eye-gaze to various observation targets;
an image processing section adapted to generate processed image data as the original image data viewed through a designed lens designed by the lens designing section;
an image moving section adapted to move the processed image data;
an image data control section adapted to control a moving distance of the processed image data moved by the image moving section based on the visual motion characteristic data; and
a display section adapted to display the processed image data.

2. The simulation device according to claim 1, wherein
the visual motion characteristic data is a ratio between a turning amount of the head of the lens user and a turning amount of the eyeballs of the lens user.

3. The simulation device according to claim 2, wherein
the image data control section has a normal mode for moving the processed image data in accordance with the turning amount of the eyeballs acquired by the visual motion characteristic data acquisition section.

4. The simulation device according to claim 2, wherein
the image data control section has a gaze mode for moving the processed image data in accordance with a total value of the turning amount of the head and the turning amount of the eyeballs acquired by the visual motion characteristic data acquisition section.

5. The simulation device according to claim 1, wherein
the lens is the progressive power lens provided with a distance portion for viewing a distance, a near portion for viewing a neighboring area, and a progressive portion having refractive power varying between the distance portion and the near portion.

6. The simulation device according to claim 5, wherein
the lens designing section designs two types of lenses, one with the large distance portion, the large near portion, or the large distance and near portions, the other with the narrow distance portion, the narrow near portion, or the narrow distance and near portions.

7. A simulation program adapted to allow the computing device to function as the simulation device according to claim 1.

8. A recording medium storing the simulation program according to claim 7 in a manner that a computing device can read the simulation program.
